(19) United States
(12) Patent Application Publication
(10) Pub. No.: US 2002/0164570 A1
(43) Pub. Date: Nov. 7, 2002

(54) Method and system for viewing images in an online educational facility

(75) Inventor: Thomas M. Sirhall, Littleton, CO (US)

Correspondence Address: LAHIVE & COCKFIELD, 28 STATE STREET, BOSTON, MA, 02109, US

(73) Assignee: Sun Microsystems, Inc.

(21) Appl. No.: 09/847,167

(22) Filed: May 1, 2001

(51) Int. Cl. G09B 3/00

(52) U.S. Cl. 434/350

(57) ABSTRACT

The present invention provides an electronic device in a distributed network for viewing images. The electronic device comprises a first module for providing a web page with an embedded software facility wherein said software facility enables a user to toggle backward and forward among images that are displayed to the user. The electronic device is also is comprised of a second module for receiving a request for the web page from a party. Further, the electronic device comprises a transmitting module for transmitting the web page to the party in response to the request.

### FIELD OF THE INVENTION

The present invention relates generally to software and more particular to a software facility for toggling forward and backwards through a series of defined images in an educational environment.

### BACKGROUND OF THE INVENTION

Some institutions currently offer education courses on-line, either as software to install directly on a stand-alone personal computer, or on a network (e.g., a local area network, or the Internet) for access by multiple computers and systems. Such on-line courses offer many benefits, including the ability of a student to avoid a commute to a traditional classroom setting, and the ability of a student to participate in a course in a more comfortable setting at the student's own pace and at convenient times. On-line educational courses may also attract more students to enroll.

To create, configure, generate, operate, and support online educational courses can require a significant amount of infrastructure and money. Therefore, there is a need for an entity, like a university or corporation, to be able to place one or more educational courses online. There exists a further need to make it possible for third-party entities to be able to create educational courses in a straightforward and efficient manner, without the significant monetary and time investment required to form their own online educational system, but by using a previously created online educational system. Such third parties further should be able to create such educational courses without the need for an extensive programming knowledge, or the need for creating such courses from scratch.

### SUMMARY OF THE INVENTION

The present invention addresses the above-described limitation by providing a software facility for toggling backward and forward a set of defined images to be viewed by a user of an online educational system. This approach provides an uncomplicated way of viewing various images in an online educational environment.

In accordance with one aspect of the present invention, in an electronic device in a distributed network, a method for viewing images is provided. The method comprises providing a web page with an embedded software facility wherein said software facility enables a user to toggle backward and forward among images that are displayed to the user. The method also is comprised of receiving a request for the web page from a party. Further, the method comprises transmitting the web page to the party in response to the request.

In accordance to another aspect of the present invention, a medium for use with an electronic device is provided, said medium containing instructions for the electronic device to perform a method is provided. The method comprises providing a web page with an embedded software facility wherein said software facility enables a user to toggle backward and forward among images that are displayed to the user. The method also is comprised of receiving a request for the web page from a party. Further, the method comprises transmitting the web page to the party in response to the request.

In accordance with another aspect of the present invention, an electronic device is provided in a distributed network for viewing images. The electronic device comprises a first module for providing a web page with an embedded software facility wherein said software facility enables a user to toggle backward and forward among images that are displayed to the user. The electronic device is also is comprised of a second module for receiving a request for the web page from a party. Further, the electronic device comprises a transmitting module for transmitting the web page to the party in response to the request.

### BRIEF DESCRIPTION OF THE DRAWINGS

The aforementioned features and advantages, and other features and aspects of the present invention, will become understood with regard to the following description and accompanying drawings; wherein:

FIG. 1 illustrates a distributed environment suitable for practicing the illustrative embodiment of the present invention;

FIG. 2 illustrates a detailed depiction of an exemplary client system in the illustrative embodiment;

FIG. 3 illustrates a detailed depiction of the flipbook;

FIG. 4 illustrates an interaction among components in the illustrative embodiment;

FIG. 5 illustrates a flowchart of the steps used by the edit module of FIG. 3 to edit information in the definition file;

FIG. 6 illustrates a flowchart of the steps used by the uploading module of FIG. 3 to upload images;

FIG. 7 illustrates a flowchart of the steps used by the tracking module of FIG. 3 to track images.

### DETAILED DESCRIPTION

The illustrative embodiment of the present invention provides a software facility for toggling backward and forward images in an online education environment. The images constitute a “flipbook” where the user may flip forward or backward various defined images at a user defined pace. The illustrative embodiment may be practical within a distributed network environment. The distributed network may include several clients and servers. These servers can run on a number of different platforms, including but not limited to UNIX, Windows, Window NT, or Solaris platforms. Those skilled in the art will appreciate that the present invention may be a practiced in a heterogeneous distributed network environment.

The applet in the illustrative embodiment of the present invention is written in the JAVA programming language. JAVA is a trademark or registered trademark of Sun Microsystems Inc. of Palo Alto, California in the United State and in other countries. In particular, the present invention utilizes applet code embedded in various HTML documents presented to the user of the online educational system. Applets are small application programs, which run automatically as soon as the associated HTML document is downloaded from a server to a client. Also, the web browser used in the present invention, such as Sun Microsystem's HotJava™, or Netscape's Navigator™ browser contain JAVA Virtual Machines for executing the applets.

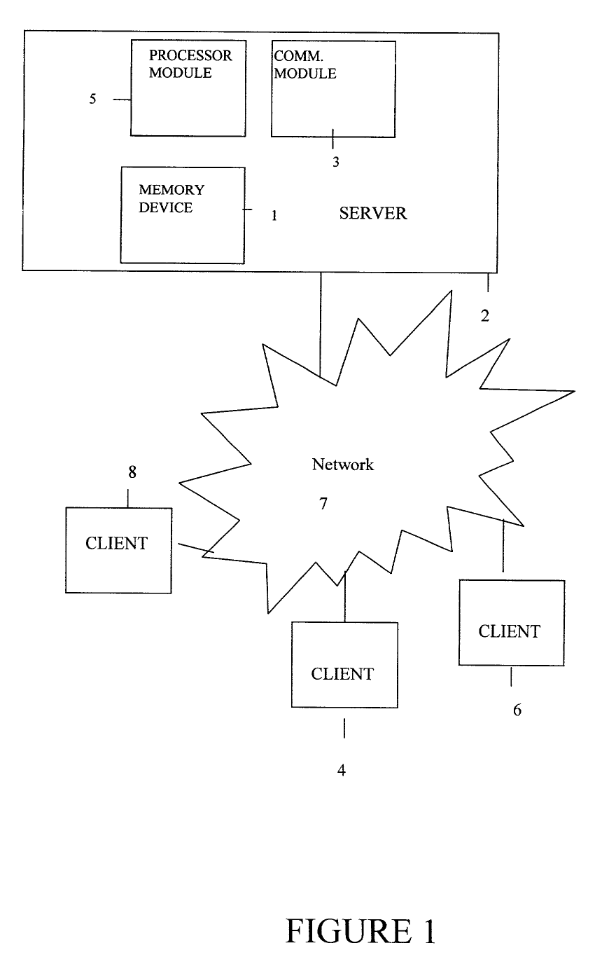

FIG. 1 illustrates a distributed environment suitable for practicing the illustrative embodiment of the present invention. The network 7 contains the server 2 and client 4,6, and 8 within. The present invention uses a server 2 for storing and transmitting HTML documents and applets to various clients 4, 6, and 8. The server 2 uses the HTTP protocol or another suitable protocol to communicate with the clients 4, 6, and 8. The server includes of a memory device 1 for storing the applets, server side code, (such as servlets) and HTML documents. Also, the server 2 has a communication module 3 for processing the requests received from the various clients 4, 6, and 8 and a processing module for processing instructions. The server 2 has a processing module 5. The server 2 communicates with the clients 4, 6, and 8 via communication link 7.

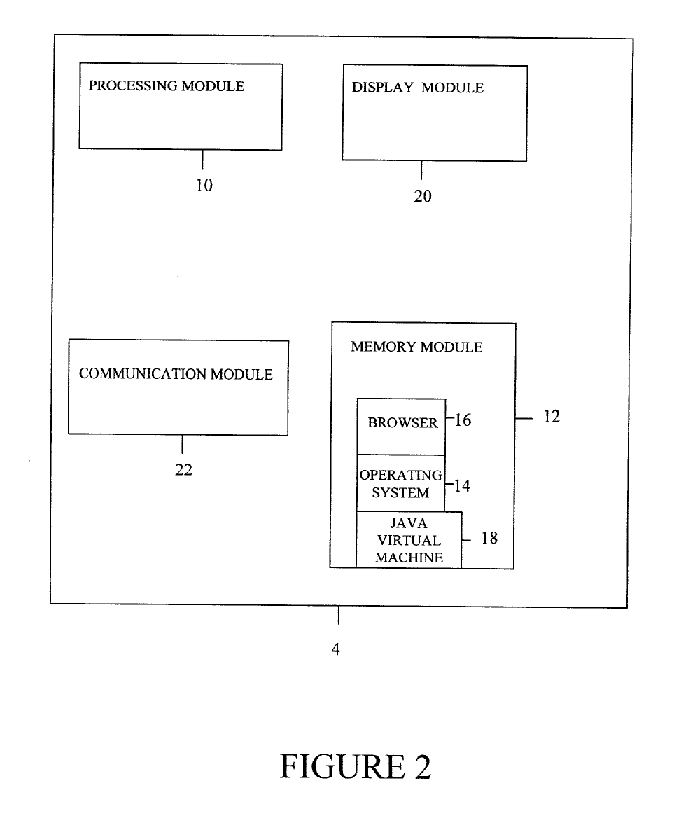

FIG. 2 provides a detailed depiction of the client system 4. The client 4 requests information from the server 2. In particular, client 4 requests HTML documents and their related applets from the server 2. Client 4 includes a processing unit 10 (such as a microprocessor) for processing the various operations done on the client 4. The client 4 also has a memory module 12 for storing programs, like an operating system 14 and browser 16. Also, the memory module 12 stores a JAVA Virtual Machine™ 18 for executing applets received from the server 2. The browser 16 is used for the display and retrieval of HTML documents from the server 2. The client 4 also has a video display for displaying information to a user. The client 4 uses a communication module 22 for communicating remotely with other elements like server 2 or sometime clients 6 and 8. The browser 16 uses the communication module 22 to communicate with server 2 to retrieve HTML documents and its associated applets. Since the present invention is a heterogeneous distributed network system, the operating system 14 of client 4 does not need to be the same as the operating system of clients 6 or 8. Similarly, the operating system of server 2 does not need to be the same as the operating systems on clients 4, 6, or 8.

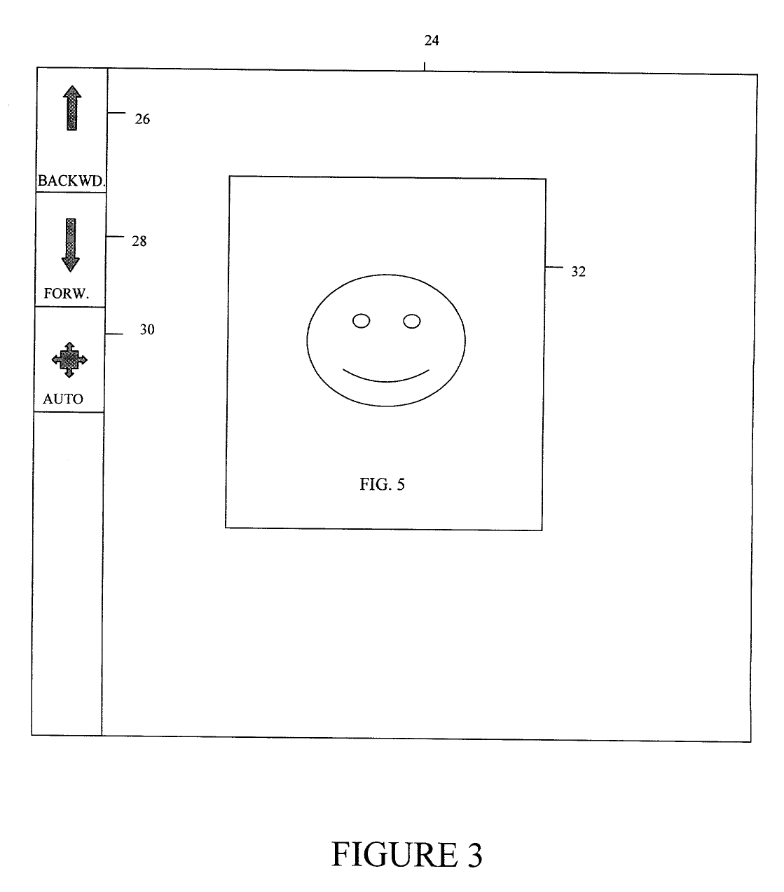

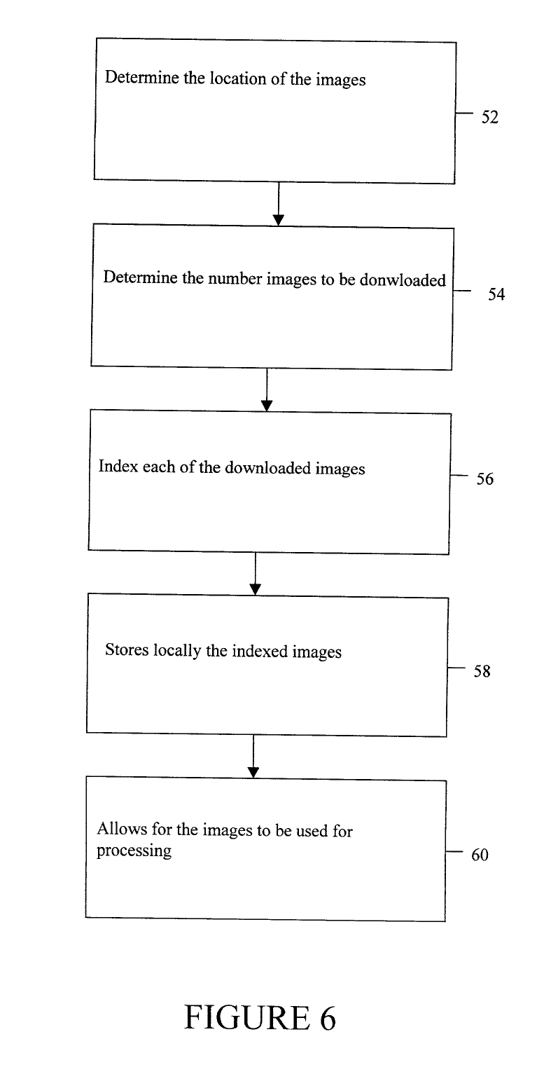

FIG. 3 illustrates a detailed depiction of the flipbook. The flipbook 24 provides for three buttons 26, 28, and 30 required for toggling the images. These buttons 26, 28, and 30 allow the user to select the next image to view. The user can select to move forward one image (FIG. 6) by pressing the forw. button 28. The user can select to move back to a previous image by pressing the backwd. button 26. The user can also select the auto command of the flipbook 24 to automatically flip images at a certain pace. Thus, allowing the user the opportunity to manually not press buttons 26 or 28 to view images. Thus, allowing the flipbook 24 to be a tool to be incorporated in an online educational tool.

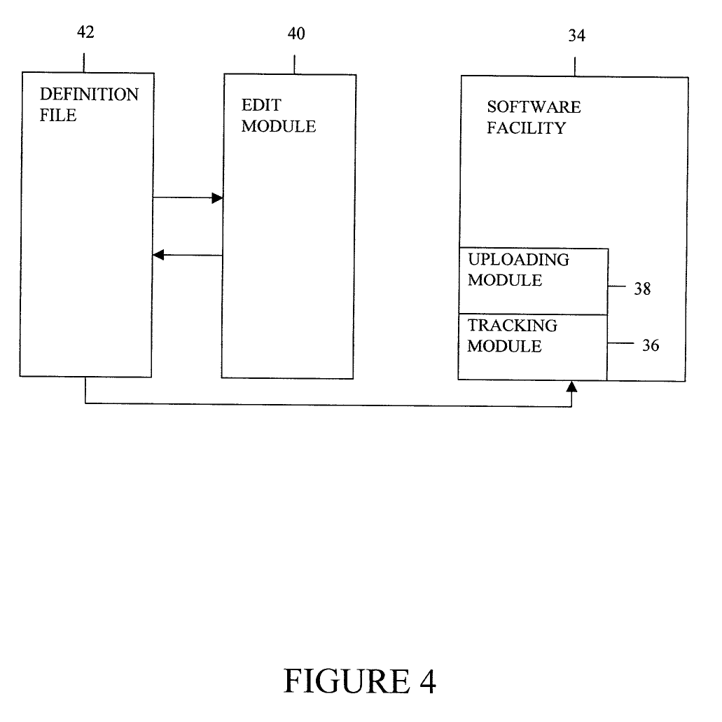

FIG. 4 illustrates interactions among components in the illustrative embodiment of the present invention. The illustrative embodiment uses a software facility 34 to toggle backwards or forwards a defined number of images in a flipbook. The software facility 34 is associated with (i.e., embedded within) an HTML document. The HTML document is downloaded from the server 2 with its associated software facility 34 to one of the clients 4, 6, or 8. Once received from the clients 4, 6, or 8, the corresponding Virtual Machine on the client 4, 6, or 8 executes the software facility 34. The software facility 34 is comprised of two functional modules. Once the applet is executed by the processing unit the clients 4, 6, or 8, invoke the uploading module 38 and the tracking module 36. The illustrative embodiment also provides an editing module 30 for editing a definition file 42. The definition file 42 allows one to modify how the software facility 34 appears to a user. The definition file 42 also contains information regarding the location of where the images are stored, user interface characteristics, and information regarding the pace of which the user wants to toggle the images. All of the contents in the definition file 42 are editable.

The uploading module 38 is used for uploading images for the flipbook from either a remote or local site. The tracking module 36 is used once the images are uploaded to process the commands for toggling the images in the flipbook forward and backwards. The illustrative embodiment uses the software facility 34 to invoke the uploading module 38 and tracking module 36 to retrieve and process the images in the flipbook. The software facility 34 reads the information in the definition file 42 to determine the appearance of the user images. The software facility 34 dynamically configures image appearance and internal characteristics based on the information in the definition file 42.

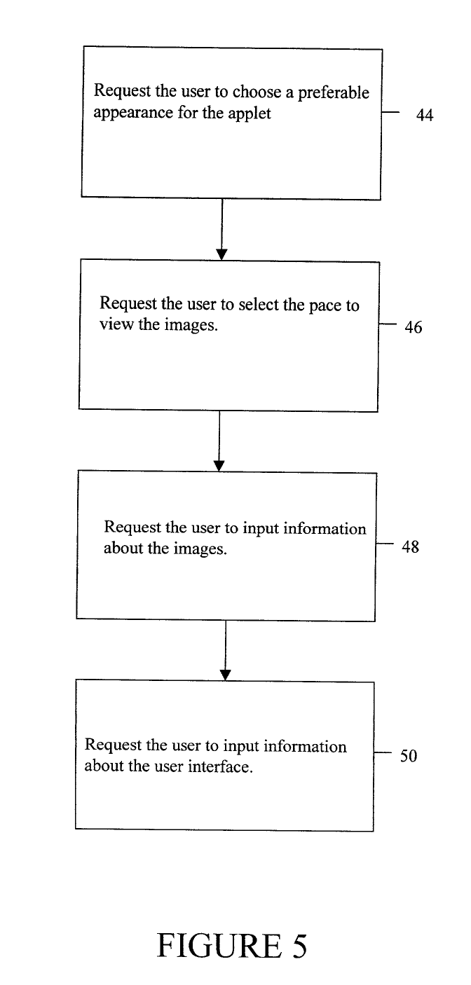

FIG. 5 illustrates a flowchart of the steps performed by the edit module 40 to edit information in the definition file 42. The edit module 40 may provide edit boxes or standard line input for editing information. First, the edit module 40 requests the user to choose which appearance is preferable to the user (step 44). The edit module 40 provides various templates as choices to the user. These templates provide different appearances for the user interface. The edit module 40 also requests the user to select the pace for which to view the images (step 46). The edit module 40 allows the user to select various pace speeds. For example, the user may select to toggle forward or backwards or the user may prefer for the system to automatically toggle forwards or backwards every 5 sec a new image. Thus, allowing the user to have the flexibility to set the pace for viewing images. The edit module 40 requests the user to input information about the images (step 48). In particular, the user inputs the location where the image may be stored, the quality of the image (number of pixels needed), and dimensional information for viewing the images. Further, the edit module 40 requests the user to input information about the user interface characteristics such as background coloring or border information (step 50).

FIG. 6 illustrates a flowchart of the steps used by the uploading module 38 to upload images. The uploading module 38 determines the location where the images are stored as shown in (step 52). The images may be stored on a remote client or server system. Thus, the uploading module 38 may need to retrieve the images from the remote site. Also, the images may be stored locally on a client system. The uploading module 38 would not need to retrieve the images remotely. The uploading module 38 retrieves the location information from the definition file 42. Once the images are retrieved, the uploading module 38 determines the number of images being used by the software facility 34 as shown in (step 54). Also, the uploading module 38 indexes each of the images for purposes of tracking as shown in (step 56). The indexed images provide information of the structure or layout of the images indexed. Thus, allowing for one to know the arrangement of images to be displayed. The tracking module 36 uses the indexed images to keep track of the usage of these images to be discussed more below. The uploading module 38 stores locally the indexed images as shown in (step 58). Afterwards, the uploading module 38 allows the tracking module 36 and the user to use the images for processing purposes as shown in (step 60).

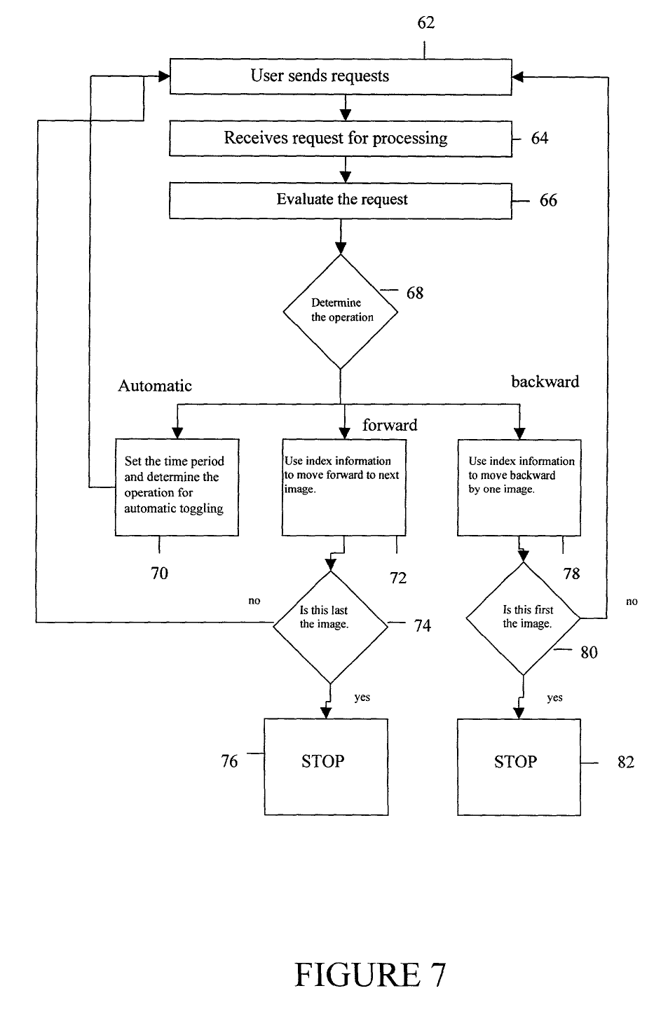

FIG. 7 illustrates a flowchart of the steps used by the tracking module 36 manage the usage of the images by a user. The user sends requests through its interaction with the software facility 34 to the tracking module 36 for operations to be done on the images as shown in (step 62). For example, the user may request to toggle an image forward. The software facility 34 directs that request to the tracking module 36. The tracking module 36 receives the request as show in (step 64). The tracking module 36 evaluates the request to determine the particular operation(s) requested as shown in (step 66). Also, the tracking module 36 determines whether the evaluated request requires toggling forward, backward, or automatic as shown in step 58. If the operation(s) is the toggling automatic feature, then the user set the time period to either toggle forward or backward on the images as shown in (step 70). If the operation(s) is to toggle forward, then the tracking module 36 uses the index information to move to the next forward one indexed image as shown in (step 72). However, if the current indexed image is the last indexed image, then the toggling forward operation is stopped as shown in (steps 74 and 76). If the operation(s) is to toggle backward, then the tracking module 36 uses the index information to move one indexed image backward as shown in (step 78). However, if the current indexed image is the first indexed image, then the toggling forward operation is stopped as shown in (steps 80 and 82).

Numerous modifications and alternative embodiments of the invention will be apparent to those skilled in the art in view of the foregoing description. Accordingly, this description illustrative only and is for the purpose of teaching those skilled in the art the best mode for carrying out the invention. Details of the structure may vary substantially without departing from the spirit of the invention, and exclusive use of all modifications that come within the scope of the appended claims is reserved. It is intended that the invention be limited only to the extent required by the appended claims and the applicable rules of law.

Having described the invention, what is claimed as new and protected by Letters Patent is:

What is claimed

1. In an electronic device in a distributed network, a method comprising the steps of:
providing a web page with an embedded software facility, wherein said software facility enables a user to toggle backward and forward among images that are displayed to the user;
receiving a request for the web page from a party; and
transmitting the web page to the party in response to the request.

2. The method of claim 1, wherein the software facility is an applet.

3. The method of claim 1, wherein the web page is an HTML document.

4. The method of claim 1, wherein the web page is an XML document.

5. The method of claim 1, wherein the software facility is automatically executed after being transmitted to the client.

6. The method of claim 5, wherein the software facility executes in a web browser environment.

7. The method of claim 1, wherein the software facility does the following when the software facility executes:
defining the appearance of a user interface to the user and a location for retrieving the images that may be displayed to the user; and
uploading the images from the location.

8. The method of claim 7, wherein the software facility when executing creates an index of the images that have been uploaded.

9. The method of claim 8, wherein the software facility determines a current location within the index such that the current location identifies the image that is currently displayed to the user via the user interface.

10. The method of claim 9, wherein the software facility modifies the current location within the index when the user takes actions indicating a desire to change which of the images displayed via the user interface.

11. The method as recited in claim 7, wherein the step of uploading further comprises uploading the images from a remote location.

12. The method as recited in claim 7, wherein the step of uploading further comprises uploading the images locally.

13. A medium for use with an electronic device, said medium containing instructions for the electronic device to perform a method, comprising the steps of:
providing a web page with an embedded software facility, wherein said software facility enables a user to toggle backward and forward among images that are displayed to the user;
receiving a request for the web page from a party; and
transmitting the web page to the party in response to the request.

14. The medium of claim 1, wherein the software facility is an applet.

15. The medium of claim 1, wherein the web page is an HTML document.

16. The medium of claim 1, wherein the web page is an XML document.

17. The method of claim 13, wherein the step for transmitting further comprises:
defining the appearance of a user interface to the user and a location for retrieving the images that may be displayed to the user; and
uploading the images from the location

18. An electronic device in a distributed network, said electronic device comprising:
a first module for providing a web page with an embedded software facility, wherein said software facility enables a user to toggle backward and forward among images that are displayed to the user;
a second module for receiving a request for the web page from a party; and
a transmitting module for transmitting the web page to the party in response to the request.

19. The electronic device as recited in claim 18 wherein the documents are markup language documents.

20. The electronic device as recited in claim 11 wherein the markup language include executable content for viewing images.
